(19) United States
(12) Patent Application Publication
(10) Pub. No.: US 2026/0357718 A1
(43) Pub. Date: Nov. 12, 2026

(54) AXIAL TURBINE FOR A TURBOMACHINE, ASSOCIATED DISMANTLING METHOD, AND USE

(71) Applicant: Accelleron Switzerland Ltd, Baden (CH)

(72) Inventors: Matthias RICHNER, Riniken (CH); Armin SCHMID, Brugg (CH); Tobias VOGT, Rickenbach (DE); Philippe PANDOLFO, Wettingen (CH)

(21) Appl. No.: 19/488,251

(22) PCT Filed: May 24, 2024
(86) PCT No.: PCT/EP2024/064430

§ 371 Date: Nov. 26, 2025

(30) Foreign Application Priority Data
Jun. 1, 2023 (EP) 23176858.1

(51) Int. Cl. F01D 25/24; F01D 9/04

(52) U.S. Cl. CPC F01D 25/246; F01D 9/047; F01D 25/243; F05D 2230/70; F05D 2240/128; F05D 2260/31

(57) ABSTRACT

An axial turbine for a turbomachine, a turbomachine, and methods for dismantling a nozzle ring are described herein. The axial turbine for a turbomachine has a turbine housing, a turbine wheel arranged in the turbine housing and mounted on a shaft, and a nozzle ring which is arranged in the turbine housing and at least partially upstream of the turbine wheel. The nozzle ring has an outer ring. Furthermore, the axial turbine comprises a cover ring which is arranged in the turbine housing and downstream of the nozzle ring, and a fastening means which detachably connects the outer ring to the cover ring radially outwardly in the axial direction. A downstream end portion of the outer ring has a radially outwardly projecting nozzle ring cam, and an upstream end portion of the cover ring has a cover ring cam holder. The nozzle ring cam engages the cover ring cam holder.

### TECHNICAL FIELD

The present disclosure relates to an axial turbine for a turbomachine, to a turbomachine, and to a method for disassembling a nozzle ring.

### BACKGROUND

To increase the performance of an internal combustion engine, use is nowadays made, as standard, of exhaust-gas turbochargers having a turbine on the exhaust-gas side of the internal combustion engine and having a compressor positioned upstream of the internal combustion engine. The exhaust gases of the internal combustion engine are expanded in the turbine. The work thus performed is transferred by means of a shaft to the compressor, which compresses the air supplied to the internal combustion engine. By using the energy of the exhaust gases to compress the air supplied to the combustion process in the internal combustion engine, it is possible to improve the performance, the combustion process and the efficiency of the internal combustion engine.

The nozzle ring of a turbocharger axial turbine is commonly fastened to the gas inlet housing or gas outlet housing by means of a screw connection. The screw connection of the nozzle ring may be implemented on the inside or on the outside of the nozzle ring.

Alternatively, the nozzle ring may also be held in place by means of a clamping connection, for example between the gas inlet housing and the gas outlet housing. Here, the dome of the gas inlet housing is normally connected to the outer part of the gas inlet housing by means of struts. It has been found that the struts between the dome and the outer part of the gas inlet housing in the flow channel can have an adverse effect on the turbine efficiency and the vibration behavior of the blades of the turbine rotor.

The aforementioned design variants lead to non-optimal structural designs with regard to the influence on efficiency and the vibration behavior, and necessitate considerable effort for disassembly and assembly, ultimately resulting in costs and increased time required for servicing.

### SUMMARY OF THE INVENTION

The object of the present invention is to provide an axial turbine which is improved with respect to at least one of the disadvantages known from the prior art.

To achieve the aforementioned object, an axial turbine for a turbomachine, and a method for disassembling a nozzle ring, are provided in accordance with the independent claims. Further embodiments, modifications and improvements will become apparent from the following description and from the appended claims.

According to an embodiment, an axial turbine for a turbomachine, in particular for an exhaust-gas turbocharger, is provided. The axial turbine has a turbine housing, a turbine impeller arranged in the turbine housing and mounted on a shaft, and a nozzle ring arranged in the turbine housing and at least partially upstream of the turbine impeller, wherein the nozzle ring has an outer ring. Furthermore, the axial turbine has a cover ring, which is arranged in the turbine housing and downstream of the nozzle ring, and a fastening means, which detachably axially connects the outer ring to the cover ring radially at the outside. A downstream end portion of the outer ring has a radially outwardly projecting nozzle ring lug, and an upstream end portion of the cover ring has a cover ring lug receptacle. The nozzle ring lug engages into the cover ring lug receptacle.

The axial direction and the radial direction are defined by the shaft of the axial turbine. A fastening means which connects the outer ring to the cover ring “radially at the outside” can be understood as meaning that the fastening means is arranged in a radially outer region of the outer ring and/or of the cover ring, in particular is arranged either at a radial end of the outer ring and/or of the cover ring or in a radially outer end portion of the outer ring and/or of the cover ring.

The term “axially” is preferably to be understood as meaning that the fastening means extends substantially in axial direction.

A “downstream end portion” comprises the downstream end and a portion in the region of the downstream end, and an “upstream end portion” comprises the upstream end and a portion in the region of the upstream end.

In the present disclosure, a “nozzle ring arranged at least partially upstream of the turbine impeller” is to be understood as meaning a nozzle ring in which a part of the nozzle ring may not be arranged upstream of the turbine impeller. However, a “nozzle ring arranged at least partially upstream of the turbine impeller” may also be understood as meaning a nozzle ring which is arranged entirely upstream of the turbine impeller.

An axial turbine is thus advantageously provided which is improved with regard to assembly and disassembly, in particular during servicing. In particular, by means of embodiments of the axial turbine that are described herein, the time required for assembly and disassembly is reduced, which has a positive effect on costs. A further advantage is that the nozzle ring lugs and cover ring lug receptacles can be produced by simple turning and milling operations, such that, for the embodiments described herein, the number of production steps can advantageously be reduced in relation to the prior art. Furthermore, the embodiments described herein make it possible to minimize screw connections. In addition, embodiments described herein advantageously make it possible to minimize potential efficiency losses and to reduce the risk of excitation of vibration of the blades of the turbine impeller.

The turbine housing may have a gas inlet housing and a gas outlet housing. The gas inlet housing may be detachably connected to the gas outlet housing by a fastening means, for example a screw connection. The turbine impeller, the nozzle ring, the cover ring, and in particular a diffuser, may be arranged within the turbine housing. The shaft may be arranged at least partially within the turbine housing. Preferably, the cover ring and/or the turbine diffuser is arranged within the gas outlet housing.

The nozzle ring may be arranged within the gas outlet housing. Typically, the nozzle ring is arranged within the gas inlet housing and the gas outlet housing. In addition to the fastening of the nozzle ring to the cover ring, the nozzle ring may also be held in place by means of a clamping connection, for example by the gas inlet housing, or by means of a clamping connection between the gas inlet housing and gas outlet housing.

The nozzle ring typically has a plurality of guide vanes formed within the outer ring. The nozzle ring may also have an inner ring. The inner ring may be formed within the guide vanes. The inner ring and the guide vanes are preferably arranged upstream of the turbine impeller. The outer ring, the guide vanes and the inner ring, and in particular the entire nozzle ring, may be of integral form. For example, the outer ring, guide vanes and inner ring may be cohesively connected to one another, or else may be manufactured from one workpiece.

The axial turbine, and in particular the gas inlet housing, may also have a dome. The dome may be arranged on an upstream end portion of the nozzle ring, and/or may be arranged in the region of the gas inlet housing. Typically, the dome is not fixed to the turbine housing. The dome preferably has no struts or the like connected to the turbine housing. The dome is therefore preferably connected neither cohesively nor by means of a screw connection to the turbine housing. In a preferred embodiment, the dome is formed integrally with the nozzle ring, in particular with the inner ring of the nozzle ring. For example, the inner ring and the dome may be cohesively connected to one another, or else may be manufactured from one workpiece. In an alternative embodiment, the dome is fastened exclusively to an inner ring of the nozzle ring.

The omission of a connection between the dome and the turbine housing can help to reduce potential efficiency losses and also the risk of excitation of vibration of the blades of the turbine impeller. Furthermore, the omission of a cohesive connection between the dome and the turbine housing, that is to say for example the omission of struts, allows access to the “inner” components of the axial turbine on the turbine side, or in other words, access from the “hot” side is made possible. This possible access is described in more detail further below.

The cover ring may be arranged within the gas outlet housing and in the region of the turbine impeller. The cover ring may surround at least one portion of the turbine impeller. The cover ring may enclose a portion of the turbine impeller radially to the outside, and delimit the flow channel radially to the outside in the region of the impeller blades. It is thus possible to prevent a fluid (for example exhaust gas) from being able to bypass the turbine impeller, in particular the impeller blades of the turbine impeller, of the axial turbine. The cover ring is typically not fastened directly to the turbine housing.

In an embodiment, the axial turbine also comprises a turbine diffuser arranged at least partially downstream of the turbine impeller. The turbine diffuser may be connected to the turbine housing, in particular to the gas outlet housing, for example by means of a screw connection.

In an embodiment, the turbine diffuser is formed integrally with the cover ring. For example, the cover ring and the turbine diffuser may be cohesively connected to one another, or else may be manufactured from one workpiece. The turbine diffuser includes the cover ring at the upstream end portion and includes a diffuser portion at the downstream end. This embodiment allows for a simpler structural design having fewer connections.

In an alternative embodiment, the cover ring is detachably connected to the turbine diffuser. In this case, a downstream end portion of the cover ring is detachably fastened to an upstream end portion of the turbine diffuser. Preferably, the axial turbine has one or more (for example 4 or 6) fastening elements which connect the turbine diffuser to the cover ring. The fastening element preferably axially connects the outer ring to the cover ring radially at the outside. The at least one fastening element may be spaced apart from the fastening means (which detachably connects the outer ring and cover ring) and from an optional clamping segment as viewed in the circumferential direction. The axial turbine may be designed for the insertion and/or loosening and removal of the fastening element via turbine-side access (or from the “hot” side). This possible access is described in more detail further below. This allows disassembly or removal of the cover ring via turbine-side access.

For example, the fastening element may extend along an insertion opening or through hole of the cover ring. Furthermore, the fastening element may engage into a thread in the turbine diffuser. The fastening element may be a pin, in particular a pin having an internal thread, a bolt, in particular a bolt having an internal thread, or a screw.

In an embodiment, the outer ring has a clamping segment, wherein the fastening means extends through an insertion opening in the clamping segment. Furthermore, the fastening means may engage into a thread in the cover ring.

The outer ring of the nozzle ring has the radially outwardly projecting nozzle ring lug and optionally the clamping segment. Typically, the outer ring is integrally connected to the clamping segment and to the nozzle ring lug.

The nozzle ring lug may be of flat form perpendicularly to the axial direction. The nozzle ring lug may be in the form of a tab. An axial extent of the nozzle ring lug may be significantly smaller than a radial extent and/or a circumferential extent. The nozzle ring lug may be a radial projection protruding from the radial end or the radial end portion of the outer ring.

The clamping segment may be of flat form perpendicularly to the axial direction. An axial extent of the clamping segment may be significantly smaller than a radial extent and/or a circumferential extent. The clamping segment may be a radial projection protruding from the radial end or the radial end portion of the outer ring.

The clamping segment may be arranged on the downstream end portion of the outer ring, and in particular may project radially from the downstream end portion of the outer ring. The clamping segment may be arranged in the vicinity of the nozzle ring lug both in the axial direction and in the circumferential direction. The clamping segment is preferably arranged upstream of and with a spacing to the nozzle ring lug. For example, the clamping segment may be mounted a few millimeters upstream of the nozzle ring lug.

In addition or alternatively, the clamping segment may at least partially overlap the nozzle ring lug as viewed in the circumferential direction. The clamping segment may have a greater extent than the nozzle ring lug as viewed in the circumferential direction. For example, the nozzle ring lug may extend entirely within the clamping segment as viewed in the circumferential direction.

In an embodiment, the clamping segment has two insertion openings or through holes. The axial turbine may also have at least two fastening means by which the outer ring is detachably connected to the cover ring. The cover ring may have at least two threads. Each of the at least two fastening means may extend through one of the insertion openings in the clamping segment. Furthermore, the at least two fastening means may engage in one of the threads in the cover ring. The fastening means may also extend through a guide hole in the cover ring. The thread may be arranged downstream of the guide hole.

The nozzle ring lug may be arranged between the two insertion openings or through holes of the clamping segment as viewed in the circumferential direction. Thus, the at least two insertion openings may each be spaced from the nozzle ring lug in the circumferential direction. For example, one of the two insertion openings may be spaced from the nozzle ring lug clockwise in the circumferential direction, and the other of the two insertion openings may be spaced from the nozzle ring lug counterclockwise in the circumferential direction.

The upstream end portion of the cover ring has the cover ring lug receptacle or groove. To fasten the nozzle ring to the cover ring, the nozzle ring can be aligned (rotated) so that the nozzle ring lug can be lowered into the cover ring lug receptacle. A tangential contact surface is formed as a result of the engagement of the lug into the lug receptacle. This allows the nozzle ring to be centered and the position of the nozzle ring as viewed in the circumferential direction to be defined. In addition, the tangential contact surface between the nozzle ring lug and the cover ring lug receptacle allows for a more reliable transmission of torque. The lug receptacle may have dimensions corresponding to the nozzle ring lug. For example, the lug receptacle may have slightly larger dimensions in the circumferential direction than the lug. This form of torque transmission between the lug and lug receptacle allows a radial expansion of the nozzle ring during operation, which improves the thermo-mechanical fatigue behavior.

According to an embodiment that may be combined with other embodiments described herein, the lug receptacle has radially extending, oppositely situated and circumferentially mutually spaced side walls for fixing the nozzle ring lug of the nozzle ring in the circumferential direction. Typically, the circumferential spacing between the two side walls is selected such that there is no clearance between the nozzle ring lug and the lug receptacle.

According to an embodiment, the cover ring has a clamping protrusion for receiving the clamping segment. The clamping protrusion may have one or more receiving portions which are of flat form and on which the clamping segment can be supported or against which the clamping segment can be pressed. The clamping protrusion may have at least one thread in the cover ring. The cover ring lug receptacle may be arranged within the clamping protrusion as viewed in the circumferential direction. In addition or alternatively, the cover ring lug receptacle may be arranged downstream of the clamping protrusion as viewed axially. The clamping protrusion may have two receiving portions. For example, one receiving portion may be spaced from the lug receptacle clockwise as viewed in the circumferential direction, and the other receiving portion may be spaced from the lug receptacle counterclockwise in the circumferential direction.

The fastening means, preferably together with the clamping segment (and optionally the clamping protrusion), allows axial fixing between the nozzle ring and the cover ring. Here, the fastening means allow the clamping segment to be pressed against the cover ring (optionally against the clamping protrusion), and the clamping segment can press the lug into the lug receptacle. In other words, axial fastening of the outer ring to the cover ring by the at least one fastening means enables the nozzle ring lug to be pressed into the cover ring lug receptacle. In particular, pressing of the clamping segment against the clamping protrusion is also made possible. The combination of the lug and lug receptacle, on the one hand, and fastening means and clamping segment, on the other hand, allows simultaneous centering and axial fastening of the nozzle ring.

According to an embodiment that may be combined with other embodiments described herein, the fastening means has an internal thread. A fastening means having an internal thread is advantageous for the removal of the fastening means during disassembly using a tool having a corresponding external thread. The fastening means may be a pin, in particular a pin having an internal thread, a bolt, in particular a bolt having an internal thread, or a screw.

The pressing of the clamping segment against the cover ring by the fastening means may also give rise to a contact surface between the clamping segment and the nozzle ring lug. Here, the pressing can cause the nozzle ring lug to push the clamping segment axially upstream or cause the nozzle ring lug to project axially into the clamping segment. The clamping segment may be bent by the nozzle ring lug and resiliently exert an axial clamping force on the nozzle ring lug.

In an embodiment, the axial turbine is configured such that, by virtue of the outer ring being axially fastened to the cover ring by the fastening means, the nozzle ring lug moves at least one portion of the clamping segment axially upstream by at least 0.05 mm, preferably at least 0.1 mm, more preferably at least 0.2 mm, and most preferably at least 0.3 mm. Alternatively or in addition, the axial turbine may be configured such that, by virtue of the outer ring being axially fastened to the cover ring by the fastening means, the nozzle ring lug projects at least 0.05 mm, preferably at least 0.1 mm, more preferably at least 0.2 mm, and most preferably at least 0.3 mm, into the clamping segment.

The cover ring, in particular the lug receptacle, may have a thread for receiving a guide rail. Here, the nozzle ring lug may have a through hole through which the guide rail extends. In addition or alternatively, the clamping segment may have a through hole (in addition to the insertion opening) through which the guide rail can extend. The guide rail makes it easier for the cover ring to be assembled with the nozzle ring.

The nozzle ring lug and the cover ring lug receptacle can also be regarded as a lug-lug receptacle pair. In an embodiment, the axial turbine has a plurality of lug-lug receptacle pairs, which are mutually spaced in the circumferential direction of the outer ring. For each lug-lug receptacle pair, the axial turbine preferably has at least one (for example two) fastening means which axially detachably connects the outer ring to the cover ring in the region of the associated lug-lug receptacle pair. In addition or alternatively, for each lug-lug receptacle pair, the axial turbine may have a clamping segment which, in particular, exerts an axial force on the associated lug-lug receptacle pair. Optionally, the axial turbine may have a clamping protrusion for each lug-lug receptacle pair. The further lug-lug receptacle pairs and/or further clamping segment-clamping protrusion pairs arranged on the axial turbine may thus be designed according to the description above.

In an embodiment, the respective lug-lug receptacle pairs differ in terms of their geometrical design. For example, the respective lug-lug receptacle pairs may differ from the other lug-lug receptacle pairs in terms of their length in the circumferential direction. It can thus be achieved that in each case only one lug can engage into a particular lug receptacle. It can thus advantageously be ensured that the nozzle ring is assembled in a particular intended orientation.

In an exemplary embodiment, the axial turbine has three lug-lug receptacle pairs and three clamping segment-clamping protrusion pairs. Each of the three clamping segment-clamping protrusion pairs may have have two insertion openings or through holes. The nozzle ring may be detachably fastened to the cover ring by six fastening means.

The axial turbine described herein advantageously allows the assembly and disassembly of various components both from a “cold” side (compressor side) and from a “hot” side (turbine side).

The axial turbine may be designed in accordance with a “cartridge concept”. The “cartridge” may comprise the shaft and the turbine impeller mounted on the shaft. After the cartridge has been dismounted, access to other components of the axial turbine, such as the diffuser, cover ring, and nozzle ring, is possible. The nozzle ring and/or the cover ring may be designed to be removed axially on the compressor side (from a “cold” side). Dismounting the nozzle ring or cover ring from a “cold” side is however time-consuming, and is sensible in particular when it is sought to carry out major repairs or maintenance rather than merely service or replace the nozzle ring or the cover ring.

Furthermore, the nozzle ring and/or the cover ring may be designed to be removed axially on the turbine side (from a “hot” side). For this purpose, at least an outer part of the gas inlet housing can be disassembled. In particular, this embodiment makes it possible to reduce the time required for assembly and disassembly, which has a positive effect on servicing costs. If it is sought merely to service or replace the nozzle ring and/or the cover ring, this can be carried out in a short required time via turbine-side access to the nozzle ring and/or the cover ring.

According to an embodiment, the axial turbine has an intermediate space between the outer ring (and optionally the cover ring) of the nozzle ring and the gas outlet housing of the turbine housing. The intermediate space allows axial access to the fastening means (in particular after parts of the gas inlet housing have been removed). This means that the fastening means can be loosened, so that the nozzle ring can be disassembled and removed from the hot side.

In a further embodiment, the intermediate space can allow axial access to the fastening element (in particular after parts of the gas inlet housing have been removed). This means that the fastening element can be loosened, so that the cover ring can be disassembled and removed from the hot side. In this case, first the nozzle ring and then the cover ring can be removed on the turbine side by virtue of the fastening means and fastening element being loosened in succession. It is alternatively also possible for only the fastening element(s) to be loosened, and for the cover ring and nozzle ring to then be removed conjointly on the turbine side.

According to a further embodiment, a turbomachine, in particular an exhaust-gas turbocharger, is provided. The turbomachine has an axial turbine according to any one of the embodiments described herein and has a compressor connected to the shaft.

According to a further embodiment, a method for disassembling a nozzle ring is provided. The nozzle ring is installed in an axial turbine and is arranged in a turbine housing of the axial turbine. The axial turbine comprises fastening means which detachably axially connect an outer ring of the nozzle ring to a cover ring of the axial turbine radially at the outside. The axial turbine may also have fastening elements which detachably axially connect the cover ring to a turbine diffuser of the axial turbine radially at the outside. The turbine housing and the nozzle ring are shaped such that an intermediate space is provided between the outer ring of the nozzle ring and the turbine housing.

In an embodiment, the method comprises the steps: removing an outer part of a gas inlet housing of the turbine housing of the axial turbine; removing the fastening means by way of axial access in the intermediate space; and removing the nozzle ring from the turbine housing axially on the turbine side.

The method may optionally also comprise the steps: removing the fastening element by way of axial access in the intermediate space; and removing the cover ring from the turbine housing axially on the turbine side.

In a further embodiment, the method comprises the steps: removing an outer part of a gas inlet housing of the turbine housing of the axial turbine; removing the fastening element by way of axial access in the intermediate space; and removing the nozzle ring and the cover ring from the turbine housing axially on the turbine side.

In particular, the method may comprise removing the nozzle ring and the cover ring conjointly from the turbine housing axially on the turbine side.

The axial turbine and/or the nozzle ring and/or the cover ring may be designed according to any one of the embodiments described herein.

In a further embodiment, the use of an assembly composed of a nozzle ring and a cover ring for turbine-side installation in and/or removal from an axial turbine for a turbomachine is described. The assembly has a nozzle ring, which has an outer ring. The nozzle ring is designed to be installed into a turbine housing of the axial turbine and to be arranged at least partially upstream of a turbine impeller of the axial turbine. Furthermore, the assembly comprises a cover ring which is designed to be installed into a turbine housing and to be arranged downstream of the nozzle ring. The assembly comprises a fastening means which axially detachably connects the outer ring to the cover ring radially at the outside. A downstream end portion of the outer ring has a radially outwardly projecting nozzle ring lug, and an upstream end portion of the cover ring has a cover ring lug receptacle. The nozzle ring lug engages into the cover ring lug receptacle.

The outer ring may have a clamping segment, wherein the fastening means extends through an insertion opening in the clamping segment. Optionally, the fastening means may engage into a thread in the cover ring.

In a further embodiment, an assembly composed of a nozzle ring and a cover ring is provided, in particular for turbine-side installation in and/or removal from an axial turbine for a turbomachine. The assembly has a nozzle ring, which has an outer ring. The nozzle ring is designed to be installed into a turbine housing of the axial turbine and to be arranged at least partially upstream of a turbine impeller of the axial turbine. Furthermore, the assembly comprises a cover ring which is designed to be installed into a turbine housing and to be arranged downstream of the nozzle ring. The assembly comprises a fastening means which axially detachably connects the outer ring to the cover ring radially at the outside. A downstream end portion of the outer ring has a radially outwardly projecting nozzle ring lug, and an upstream end portion of the cover ring has a cover ring lug receptacle. The nozzle ring lug engages into the cover ring lug receptacle.

The outer ring may have a clamping segment, wherein the fastening means extends through an insertion opening in the clamping segment. Optionally, the fastening means may engage into a thread in the cover ring.

### BRIEF DESCRIPTION OF THE FIGURES

The invention will be discussed in more detail below on the basis of embodiments, without these being intended to limit the scope of protection that is defined by the claims.

The accompanying drawings illustrate embodiments and serve, together with the description, for explaining the principles of the invention. The elements in the drawings are relative to one another and are not necessarily true to scale. The same reference signs are used to denote correspondingly similar parts.

In the figures:

FIG. 1 shows an axial turbine according to an embodiment in an exploded drawing.

FIG. 2 shows a part of an axial turbine according to an embodiment.

FIG. 3 shows a part of an axial turbine according to an embodiment.

FIG. 4 shows an enlarged view of a region from FIG. 3.

FIG. 5 shows an axial turbine according to an embodiment.

### DETAILED DESCRIPTION

The following detailed description makes reference to the accompanying drawings, which illustrate a part thereof and in which specific embodiments in which the invention can be implemented are shown by way of illustration. It should be understood that other embodiments may be used, and structural or logical changes may be made, without departing from the scope of protection of the present invention. The following detailed description is therefore not intended to be interpreted in a limiting manner, and the scope of protection of the present invention is defined by the appended claims. The embodiments described use specific language, which is not to be interpreted as limiting the scope of protection of the appended claims.

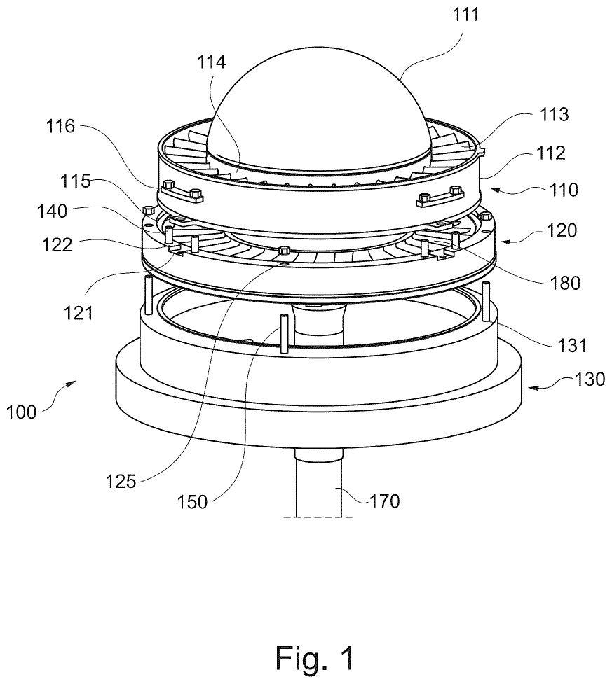

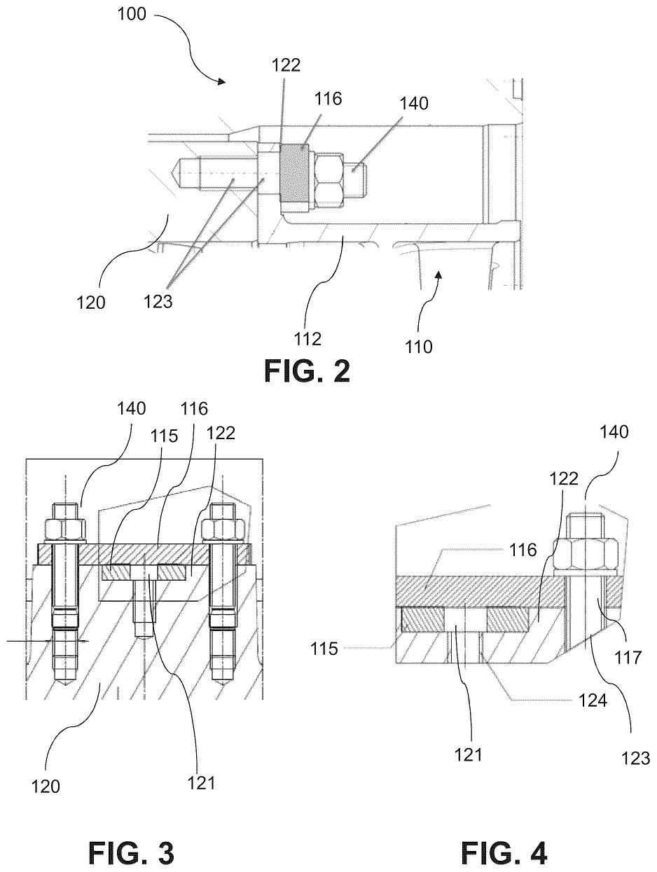

FIGS. 1 and 2 show a part of an axial turbine 100 for a turbomachine according to an embodiment. In order to provide a better overview, some components of axial turbine 100 are not shown. In particular, the axial turbine 100 has a turbine housing, a shaft 170, and a turbine impeller 180 arranged in the turbine housing and mounted on the shaft 170. FIG. 1 is in the form of an exploded drawing. The components of axial turbine 100 are thus shown in an non-assembled state.

The axial turbine 100 has a nozzle ring 110. The nozzle ring 110 has an outer ring 112, an inner ring 114 and guide vanes 113, which are arranged between the outer ring 112 and the inner ring 114. The turbine housing has a dome 111, which is connected to the nozzle ring 110. Here, the outer ring 112, guide vanes 113, inner ring 114 and dome 111 are all of integral form. The nozzle ring 110 is arranged within the turbine housing (not shown).

Furthermore, the axial turbine 100 has a cover ring 120. The cover ring is arranged within the turbine housing (not shown) and downstream of the nozzle ring 110.

The axial turbine 100 has six fastening means 140 which detachably axially connect the outer ring 112 to the cover ring 120 radially at the outside. In this case, the outer ring 112 has three clamping segments 116, and the cover ring 120 has three clamping protrusions 122 (only two clamping segments 116 and two clamping protrusions 122 are illustrated fully in FIG. 1). In each case two fastening means 140 connect a clamping segment 116 to the outer ring 112.

Furthermore, the outer ring 112 has three nozzle ring lugs 115, and the cover ring 120 has three corresponding lug receptacles 121 (only one nozzle ring lug 115 and one lug receptacle 121 are illustrated fully in FIG. 1).

The axial turbine 100 also comprises a turbine diffuser or diffuser 130. The diffuser 130 and the cover ring 120 are each formed as separate components and are connected to one another by means of fastening elements 150, the cover ring 120 has a plurality of insertion openings 125, and the turbine diffuser 130 has a corresponding number of threads 131 for receiving the fastening elements 150. The fastening elements 150 each extend through one of the insertion openings 125 and engage into one of the threads 131 in the diffuser 130.

FIGS. 2 and 3 each show a sectional drawing of the axial turbine 100 according to an embodiment. The region shown in FIGS. 2 and 3 illustrates the connection between the nozzle ring 110 and the cover ring 120.

The nozzle ring lug 115 of the nozzle ring 110 rests on the corresponding lug receptacle 121 of the cover ring 120. The clamping segment 116 of the nozzle ring 110 rests on the clamping protrusion of the cover ring 120.

By fastening the two fastening means 140 shown, the clamping segment 116 is pressed against the clamping protrusion 122. The pressing of the clamping segment 116 against the clamping protrusion 122 causes the nozzle ring lug 115 to be pressed against the lug receptacle 121. Whilst there may be an axial spacing between the nozzle ring lug 115 and the clamping segment 121 in a non-assembled state, the nozzle ring lug 115 and the clamping segment 121 come into contact with one another as a result of the nozzle ring 110 and the cover ring 120 being connected, whereby a contact surface is created between the nozzle ring lug 115 and the clamping segment 121. Here, the pressing can cause the nozzle ring lug 115 to push the clamping segment 121 axially upstream or cause the nozzle ring lug 115 to project axially into the clamping segment 121. The projection of the nozzle ring lug 115 into the clamping segment 121 is indicated by a thick black line in FIG. 3, and even more clearly in the enlarged illustration in FIG. 4.

The cover ring 120 may have a thread 124 for receiving a guide rail. Here, the nozzle ring lug 115 may have a through hole through which the guide rail extends. In addition or alternatively, the clamping segment 121 may have a through hole (in addition to the insertion opening 117) through which the guide rail can extend. The guide rail makes it easier for the cover ring 120 to be assembled with the nozzle ring 110.

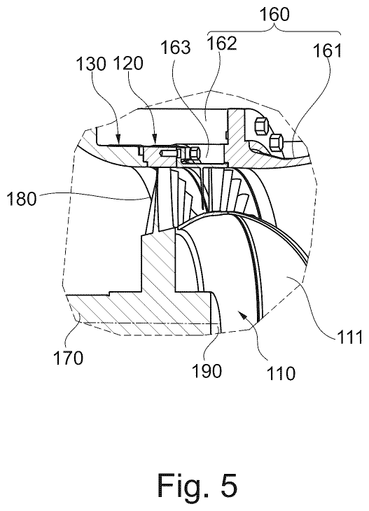

FIG. 5 illustrates the axial turbine 100 with nozzle ring 110, cover ring 120 and diffuser 130. The axial turbine 100 has a turbine housing 160. The turbine housing comprises a gas inlet housing 161 and a gas outlet housing 162. The diffuser 130 and the cover ring 120 are arranged within the gas outlet housing 162. The nozzle ring 110 is arranged partially within the gas inlet housing 161 and partially within the gas outlet housing 162. The nozzle ring 110 and gas outlet housing 162 are shaped such that an intermediate space 163 is formed. The intermediate space 163 allows axial access to the nozzle ring 110 after the gas inlet housing 161 has been at least partially removed. This allows access to the fastening means 140. After the fastening means 140 have been loosened and removed, the nozzle ring 110 can be removed on the turbine side.

Here, the shaft 170 defines the longitudinal axis 190 or the axial direction and the radial direction. FIG. 5 illustrates the longitudinal axis 190 as a dash-dotted line.

Furthermore, the intermediate space 163 can allow access to the fastening element 150. After the fastening elements 150 have been loosened and removed, the cover ring 120 can be removed on the turbine side.

Although specific embodiments have been illustrated and described herein, it falls within the scope of the present invention to suitably combine or modify the embodiments shown, without departing from the scope of protection of the present invention.

### LIST OF REFERENCE SIGNS

110 Nozzle ring
111 Dome
112 Outer ring
113 Guide vanes (of the nozzle ring)
114 Inner ring (of the nozzle ring)
115 Nozzle ring lug
116 Clamping segment
117 Insertion opening
120 Cover ring
121 Lug receptacle
122 Clamping protrusion
123 Guide hole
124 Thread for receiving a guide rail
125 Insertion opening in the cover ring
130 Turbine diffuser
131 Thread in the turbine diffuser (for receiving the fastening element)
140 Fastening means
150 Fastening element
160 Turbine housing
161 Gas inlet housing
162 Gas outlet housing
163 Intermediate space
170 Shaft
180 Turbine impeller
190 Longitudinal axis

1-15. (canceled)

16. An axial turbine for a turbomachine comprising:
a turbine housing;
a turbine impeller arranged in the turbine housing and mounted on a shaft;
a nozzle ring arranged in the turbine housing and at least partially upstream of the turbine impeller, wherein the nozzle ring has an outer ring;
a cover ring arranged in the turbine housing and downstream of the nozzle ring,
a fastening means which detachably axially connects the outer ring to the cover ring radially at the outside;
wherein a downstream end portion of the outer ring has a radially outwardly projecting nozzle ring lug, and an upstream end portion of the cover ring has a cover ring lug receptacle, and wherein the nozzle ring lug engages into the cover ring lug receptacle.

17. The axial turbine as claimed in claim 16, further comprising a dome which is arranged on an upstream end portion of the nozzle ring, wherein the dome is fastened exclusively to an inner ring of the nozzle ring or wherein the dome is formed integrally with the nozzle ring.

18. The axial turbine of claim 16, wherein the outer ring has a clamping segment, wherein the fastening means extends through an insertion opening in the clamping segment.

19. The axial turbine of claim 18 wherein the fastening means engages into a thread in the cover ring.

20. The axial turbine as claimed in claim 18, wherein the nozzle ring lug projects at least 0.05 mm into the clamping segment.

21. The axial turbine as claimed in claim 18, wherein the clamping segment has two insertion openings, wherein the nozzle ring lug is arranged between the two insertion openings as viewed in the circumferential direction.

22. The axial turbine of claim 18, wherein the clamping segment is arranged upstream of and so as to be spaced from the nozzle ring lug.

23. The axial turbine of claim 18, wherein the clamping segment at least partially overlaps the nozzle ring lug as viewed in the circumferential direction.

24. The axial turbine of claim 18, wherein the cover ring has a clamping protrusion for receiving the clamping segment.

25. The axial turbine of claim 16, wherein the axial turbine is configured such that, by virtue of the outer ring being axially fastened to the cover ring by the fastening means, the nozzle ring lug is pressed into the cover ring lug receptacle.

26. The axial turbine of claim 16, further comprising a turbine diffuser arranged at least partially downstream of the turbine impeller.

27. The axial turbine as claimed in claim 26, wherein the turbine diffuser is formed integrally with the cover ring.

28. The axial turbine as claimed in claim 26, wherein a downstream end portion of the cover ring is fastened to an upstream end portion of the turbine diffuser.

29. The axial turbine of claim 28, wherein the turbine diffuser is detachably connected to the cover ring by means of a fastening element, wherein the fastening element extends along an insertion opening of the cover ring and engages into a thread in the turbine diffuser.

30. The axial turbine of claim 16, wherein the nozzle ring lug and the cover ring lug receptacle form a lug-lug receptacle pair, and the axial turbine has at least three lug-lug receptacle pairs which are mutually spaced in the circumferential direction of the outer ring.

31. The axial turbine of claim 16, wherein the nozzle ring and/or the cover ring is designed to be removed axially on the turbine side.

32. A method for disassembling a nozzle ring which is installed in an axial turbine and arranged in a turbine housing of the axial turbine,
wherein the axial turbine has fastening means which detachably axially connect an outer ring of the nozzle ring to a cover ring of the axial turbine radially at the outside;
wherein the turbine housing and the nozzle ring are shaped such that an intermediate space is provided between the outer ring of the nozzle ring and the turbine housing, the method comprising:
removing an outer part of a gas inlet housing of the turbine housing of the axial turbine;
removing the fastening means by way of axial access in the intermediate space; and removing the nozzle ring from the turbine housing axially on the turbine side.

33. The method of claim 32, wherein the axial turbine has fastening elements which detachably axially connect the cover ring to a turbine diffuser of the axial turbine radially at the outside, the method further comprising:
removing the fastening element by way of axial access in the intermediate space; and removing the nozzle ring and the cover ring from the turbine housing axially on the turbine side.

34. The use of an assembly composed of a nozzle ring and a cover ring for turbine-side installation in and/or removal from an axial turbine for a turbomachine, the assembly comprising:
a nozzle ring which has an outer ring and is designed to be installed into a turbine housing of the axial turbine and to be arranged at least partially upstream of a turbine impeller of the axial turbine;
a cover ring which is designed to be installed into a turbine housing and to be arranged downstream of the nozzle ring,
a fastening means which detachably axially connects the outer ring to the cover ring radially at the outside;
wherein a downstream end portion of the outer ring has a radially outwardly projecting nozzle ring lug, and an upstream end portion of the cover ring has a cover ring lug receptacle, and wherein the nozzle ring lug engages into the cover ring lug receptacle.
